(19) United States
(12) Patent Application Publication
(10) Pub. No.: US 2005/0170081 A1
(43) Pub. Date: Aug. 4, 2005

(54) Method & material for refurbishing vinyl and other painted surfaces

(75) Inventor: Mark A. Latkovic, Cleveland, OH (US)

Correspondence Address: BROUSE MCDOWELL, 388 SOUTH MAIN STREET, SUITE 500, AKRON, OH, 44311-4407, US

(73) Assignee: The Flood Company

(21) Appl. No.: 10/767,984

(22) Filed: Jan. 29, 2004

(51) Int. Cl. B05D 7/00

(52) U.S. Cl. 427/140

(57) ABSTRACT

A method and material for refurbishing vinyl and other painted surfaces includes the steps of cleaning the surface with a detergent, drying the surface, applying a revitalizer to the surface, and drying the surface such that the surface has an improved appearance. The surface may be vinyl or other painted surfaces, which may take the form of shutters, gutters and siding. Further, the improved method may also include the step of priming the surface prior to applying the revitalizer in order to promote adhesion of the revitalizer to the surface.

### I. BACKGROUND OF THE INVENTION

A. Field of Invention

This invention pertains to the art of methods and materials for refurbishing the appearance of vinyl and other painted surfaces.

B. Description of the Related Art

Vinyl substrates and other painted surfaces, such as plastic, wood or metal, are often utilized to produce many sorts of common and useful products, such as window shutters and siding for homes and commercial buildings. Because these surfaces are continuously exposed to the elements, sometimes the surfaces lose their lustrous appearances. Over time, these surfaces can become dulled and chalked due to constant exposure to the sun, rain, snow and other various weather elements. Rather than replacing vinyl siding or painted plastic shutters, it is economically advantageous to treat the weathered surface with a material to restore its original appearance as closely as possible.

While other methods and materials may exist in the art to refinish weathered surfaces, a need exists to provide a material and method for revitalizing the appearance of weathered surfaces that is easy and economically advantageous.

### II. SUMMARY OF THE INVENTION

According to one aspect of the present invention, a new and improved method and material for refurbishing vinyl and other painted surfaces is provided which comprises the steps of:
cleaning the weathered surface;
drying the weathered surface;
applying a revitalizer to the weathered surface; and
drying the weathered surface such that the surface has an improved appearance.

Further, another object of the present invention is to provide a method and material for refurbishing vinyl and other painted surfaces, wherein the revitalizer is a polymer coating.

Still, another object of the present invention is to provide a method and material for refurbishing vinyl and other painted surfaces, wherein the revitalizer is a clear coating.

Further yet, another object of the present invention is to provide a method and material for refurbishing vinyl and other surfaces, wherein the revitalizer is a clear, polymer coating.

Another object of the present invention is to provide a method and material for refurbishing vinyl and other painted surfaces, wherein the surface is a painted (polystyrene or polypropylene) or plastic and/or metal shutter.

It is yet another object of the present invention is to provide a method and material for refurbishing vinyl and other painted surfaces, wherein the surface is vinyl siding.

Still yet, another object of the present invention is to provide a method and material for refurbishing vinyl and other painted surfaces, wherein the or metal surface is a gutter.

It is yet another object of the present invention is to provide a method and material for refurbishing vinyl and other painted surfaces, further comprising the step of painting the weathered surface prior to applying the revitalizer.

Still, another object of the present invention is to provide a method and material for refurbishing vinyl and other painted surfaces, wherein the revitalizer improves renews or rejuvenates the color or the vinyl surface.

Further, another object of the present invention is to provide a method and material for refurbishing vinyl and other painted surfaces, wherein the weathered surface is cleaned with a detergent.

Another object of the present invention is to provide a method and material for refurbishing vinyl and other painted surfaces, wherein at least one of the steps of drying the weathered surface is through ambient air.

It is yet another object of the present invention is to provide a method and material for refurbishing vinyl and other painted surfaces, wherein at least one of the steps of drying the weathered surface is through forced air.

Still another object of the present invention is to provide a method and material for refurbishing vinyl and other painted surfaces, wherein the weathered surface is cleaned with a power washer.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a flow chart illustrating the steps of the present invention.

### IV. DESCRIPTION OF THE PREFERRED EMBODIMENT

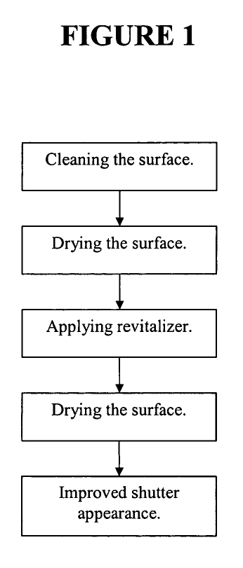

Referring now to the drawings wherein the showings are for purposes of illustrating a preferred embodiment of the invention only and not for purposes of limiting the same, FIG. 1 shows a flow chart illustrating the steps of the present invention. A method for revitalizing a surface comprises the steps of cleaning the surface, drying the surface, applying a revitalizer to the surface and drying the surface such that the surface has an improved appearance. The improved appearance includes restoration of the original color of the surface. The revitalizer simultaneously provides a protective coating that would maintain a semi-gloss, or low lustre finish for a period of time such that the surface can withstand further exposure to the sun, rain, snow, or other elements. The surface may be a vinyl surface, which is molded or extruded, or a painted surface, such as plastic, wood or metal, taking the form of a shutter, shutter casings, doors, door frames, siding, gutters or other similar part. The painted surface may be painted with an acrylic latex paint or a solvent-based alkyd paint. The surface may also be thermoplastic polyolefin (TPO). It is also contemplated to be within the scope of the present invention that the surface may have an industrially applied coating, which is cured at elevated temperatures in excess of 120° F. Shutters, siding and gutters of both residential and commercial settings may benefit from the novel and inventive method.

The weathered surface may generally be cleaned with a detergent chosen in accordance with sound engineering judgment, such as, but not limited to, a solution containing bleach. The surface may be cleaned with a power washer, spray hose, compressor washer, power washer, or any other means chosen in accordance with sound engineering judgment.

The revitalizer should be a clear, polymer coating or a clear, polymer solution and may be applied through any method chosen with sound engineering judgment, including, but not limited to application with a brush. The polymer can be of any variety of polymers that can be applied in liquid form, and that are clear, providing an attractive sheen to the surface. One example of such polymer may be an acrylic polymer, alkyd or polyurethane.

Drying the weathered surface may be through ambient air, forced air, and/or heat. During cleaning, surface debris and chalk marks may be removed which smoothes the surface. Application of the revitalizer provides for more smoothing effects. By smoothing the surface, the appearance is improved because light reflection increases. This is analogous to having a cake with a rough surface and smoothing frosting over it to improve its appearance. In other words, the surface irregularities of the shutter are filled in by the revitalizer, thereby making the appearance smoother.

It is also contemplated to be within the scope of the present invention to revitalize surfaces that are made of a TPO composition, which is generally a mixture of polypropylene and EPDM rubber. In order for the revitalizer to have proper adhesion to the TPO surface, the surface may be primed and allowed to dry. Then the revitalizer may be applied to improve the appearance of the surface. In another embodiment, the revitalizer may be a self-adhering paint or primeness paint, such that priming and revitalizing can occur in one step.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A method for revitalizing a surface, comprising the steps of:
cleaning the surface;
drying the surface;
applying a revitalizer to the surface; and
drying the surface such that the surface has an improved appearance.

2. The method of claim 1, wherein the revitalizer is a polymer coating.

3. The method of claim 1, wherein the revitalizer is a clear coating.

4. The method of claim 1, wherein the revitalizer is a clear, polymer coating.

5. The method of claim 1, wherein the surface is a plastic shutter.

6. The method of claim 1, wherein the surface is vinyl siding.

7. The method of claim 1, wherein the surface is a gutter.

8. The method of claim 1, further comprising the step of:
painting the surface prior to applying the revitalizer.

9. The method of claim 1, wherein the revitalizer improves the color of the surface.

10. The method of claim 9, wherein after the revitalizer dries, the surface has a protective, glossy finish.

11. The method of claim 1, wherein the surface is cleaned with a detergent.

12. The method of claim 1, wherein the surface is a vinyl substrate.

13. The method of claim 1, wherein the surface is a painted surface.

14. A method for revitalizing a surface, comprising the steps of:
cleaning the surface;
drying the surface;
priming the surface
applying a revitalizer to the surface;
drying the surface such that the surface has an improved appearance.

15. The method of claim 14, wherein, the revitalizer is a polymer solution.

16. The method of claim 15, wherein the revitalizer is a clear.

17. The method of claim 14, wherein the surface is a metal shutter.

18. The method of claim 14, wherein the surface is vinyl siding.

19. A method for revitalizing shutters on a house, the method comprising the steps of:
cleaning the shutter with a detergent;
drying the shutter;
applying a revitalizer to the shutter;
drying the shutter so as to improve the color and of the shutter and provide a protective, glossy finish to the vinyl shutter.

20. The method of claim 19, further comprising the step of painting the shutter prior to applying the revitalizer.
